(19) United States
(12) Patent Application Publication
(10) Pub. No.: US 2017/0346125 A1
(43) Pub. Date: Nov. 30, 2017

(54) VANADIUM ACTIVE MATERIAL SOLUTION AND VANADIUM REDOX BATTERY

(71) Applicants: Galaxy Corporation, Tokyo (JP); Chikouji Gakuen Educational Foundation, Saitama (JP)

(72) Inventors: Kaoru HOSOBUCHI, Tokyo (JP); Hiroaki MATSUURA, Saitama (JP)

(73) Assignees: Galaxy Corporation, Tokyo (JP); Chikouji Gakuen Educational Foundation, Saitama (JP)

(21) Appl. No.: 15/538,177

(22) PCT Filed: Dec. 22, 2015
(86) PCT No.: PCT/JP2015/085827

§ 371 Date: Jun. 20, 2017

(30) Foreign Application Priority Data
Dec. 25, 2014 (JP) 2014-261504

(51) Int. Cl. H01M 8/18; H01M 8/02; H01M 8/22; H01M 8/0234

(52) U.S. Cl. CPC H01M 8/188; H01M 8/02; H01M 8/225; H01M 8/0234

(57) ABSTRACT

[Problem to be Solved] To provide a vanadium active material solution which has a vanadium active material concentration of 2.5 M or more in a sulfuric acid solution including a dispersoid (suspensible material), can stably maintain high energy density based on the concentration, and can respond also to fast charge and discharge, and to provide a vanadium redox battery using the active material solution.

[Solution] The above problem is solved by a vanadium active material solution comprising a vanadium compound, which is an active material, as a solute and a dispersoid, wherein the total concentration of vanadium is 2.5 M or more. Here, in a negative electrolyte, the vanadium compound comprises one or both of bivalent and trivalent vanadium. In a positive electrolyte, the vanadium compound comprises one or both of quadrivalent and pentavalent vanadium. In an active material solution, the vanadium compound comprises one or both of trivalent and quadrivalent vanadium. The average diameter of the dispersoid is in the range of 1 nm or more and 100 μm or less.

### FIELD OF THE INVENTIONS

The present invention relates to a battery active material solution using a vanadium compound as a solute and a dispersoid (hereinafter, referred to as a vanadium active material solution) and to a battery using the active material solution (hereinafter, referred to as a vanadium redox battery). More specifically, the present invention relates to a vanadium active material solution and a vanadium redox battery which has high battery capacity and high energy density accompanying an increase in active material concentration and can stably maintain the high battery capacity and high energy density over a long period of time.

### BACKGROUND OF THE INVENTIONS

The practical utilization and development of redox batteries have been advanced mainly as a flow-type battery or a capacitor-type secondary battery, using a vanadium compound, an iron compound, a chromium compound, halogen, or the like as a battery active material. In a redox battery, an electrode itself is not changed by charge and discharge, but the redox state (valence) of an active material fed to the electrode is changed. Therefore, a reduction in battery capacity or the like due to the degradation of an electrode does not easily occur in a redox battery, and it is considered that the redox battery is a battery with which a long life is guaranteed compared with a lead battery, a lithium ion battery, a sodium-sulfur battery, and other batteries. Among the redox batteries, a battery using a vanadium compound as an active material can generate relatively high electromotive force by using a divalent vanadium compound as a negative electrode active material and a pentavalent vanadium compound as a positive electrode active material. In this battery, if an increase in density (increase in concentration) of the active material made of a vanadium compound can be achieved, energy density can be increased. As a result, small energy density which has been conventionally pointed out as shortcomings of redox batteries can be improved.

A vanadium redox battery is constituted by using an electrolytic cell (cell stack) separated into a positive electrode and a negative electrode with a diaphragm such as an ion exchange membrane and putting vanadium compounds each having a different valence in a positive electrode chamber and a negative electrode chamber, respectively. The charge-discharge reaction of formula (1) occurs at the positive electrode, and the charge-discharge reaction of formula (2) occurs at the negative electrode. Note that, in formulas (1) and (2), the reactions proceed from right to left during discharge and from left to right during charge.

[Formula 1]

(Positive Electrode)

VO²⁺(quadrivalent)+H₂O [symbol] VO₂⁺(pentavalent)+2H⁺+e⁻ (1)

(Negative Electrode)

V³⁺(trivalent)+e⁻ [symbol] V²⁺(bivalent) (2)

When a vanadium active material solution used in a vanadium redox battery is prepared from vanadyl sulfate (vanadium oxysulfate: VOSO4.nH2O), vanadyl sulfate is first dissolved in a sulfuric acid aqueous solution to prepare a vanadyl ion solution of quadrivalent vanadium. Then, the vanadyl ion solution is electrolyzed in an electrolytic cell of an electrolytic solution circulation type (flow type), and the redox state (valence) is adjusted to prepare a positive electrolyte and a negative electrolyte.

Various prior arts have been reported on a vanadium active material solution used in the vanadium redox battery. The concentration of a vanadium active material has been normally suppressed to about 2 M (mol) or less except a battery of a type in which the active material is supported on an electrode without being circulated. A vanadium active material concentration of 2 M refers to the concentration of a vanadium active material solution containing twice the Avogadro's number of vanadium elements in 1 L. The reason for suppressing the concentration of the vanadium active material to about 2 M or less is for preventing the precipitation of a vanadium compound in a tank or the like for storing the active material, including both a positive electrolyte and a negative electrolyte. In a redox battery generally having low energy density, such suppression of concentration is the largest factor that prevents an improvement in energy density.

The precipitation of a vanadium compound is also prevented in a capacitor-type vanadium redox battery in which a flow-type electrolytic cell (body of a redox battery) is filled with a vanadium active material solution, which is used stationarily or almost without flowing. In a capacitor-type vanadium redox battery, in order to avoid the precipitation of a vanadium compound in a carbon fiber aggregate (felt, cloth, or the like) which is an electrode, the possibility of an increase in concentration of the vanadium active material up to 3.5 M is partly indicated (refer to Non Patent Literature 1). However, the vanadium active material is actually used at a concentration of 2 M or less (refer to Non Patent Literature 2).

Note that FIG. 4 is a schematic diagram showing a method for producing an active material solution for a positive electrode and an active material solution for a negative electrode of a conventional type. FIG. 5 is a schematic diagram illustrating the principle of a conventional common vanadium redox battery.

### CITATION LIST

### Patent Literature

Patent Literature 1: Japanese Patent Laid-Open No. 8-64223
Patent Literature 2: Japanese Patent Laid-Open No. 2002-367657
Patent Literature 3: International Publication No. WO 2013-058375

### Non-Patent Literature

Non-Patent Literature 1: F. Rahman et al., “Vanadium Redox Battery: Positive half-cell electrolyte studies,” 189, Journal of Power Sources, 1212-1219 (2009).
Non-Patent Literature 2: Shunichi Uchiyama et al., “Possibility of Redox Supercapacitors,” 37th Battery Discussion, 3C08 (1996).

### SUMMARY OF THE INVENTION

### Technical Problem

When an active material solution having a vanadium active material concentration of higher than 2 M to about 3 M is intended to be prepared, the precipitation of an active material cannot be avoided and the active material will be suspended in the process of preparation. At this time, it is important to stably maintain, in the active material solution, a precipitate of the active material and/or a dispersoid of the active material which causes the suspension. The precipitation and/or deposition of the active material in the active material solution may occur also in an aqueous sulfuric acid solution of vanadyl sulfate having high solubility. In an active material solution to which a means to stably maintain the precipitate and/or the dispersoid of the active material is not applied, cell reaction is inhibited by the precipitation of a vanadium compound.

For example, when halide ions are allowed to coexist in the active material solution to take a means to achieve the stability particularly of a positive electrolyte, a problem of fluidity reduction which has been a large problem relating to an increase in concentration will be relieved, and a stable easy-to-use properties will be obtained. However, if the concentration of a vanadium compound exceeds 2.5 M, the precipitation of a complex salt containing sulfate ions (hydrogensulfate ions) and/or halide ions will be observed after leaving the active material solution for a long time (for example, several weeks). Further, depending on the case, an aggregated precipitate is formed by crystal growth. This is a drawback of being directly connected to a reduction in the capacity of a vanadium redox battery.

On the other hand, a vanadium compound easily precipitates in an electrode, for example, in a capacitor-type vanadium redox battery using an active material solution having a vanadium active material concentration of 2.5 M or more. Then, when the precipitation is significant, the precipitates firmly bind to a carbon fiber aggregate which is an electrode, and the binding part stops acting as an electrode. Further, also in the case of a redox battery which uses a particulate vanadium compound as an active material from the beginning, an electrode reaction will not proceed since the particle size of the particulate vanadium compound will increase by crystal growth. Therefore, this causes significant capacity reduction.

Further, Patent Literature 3 has proposed a high energy density battery using an active material solution having an active material concentration of 2.5 M or more. This battery is a battery that performs charge and discharge while maintaining the solution properties in which a suspensible active material is not produced. However, if a crystalline vanadium compound is produced in the active material solution of such a battery, crystal growth will proceed, and the proportion of an active material which is difficult in electrode reaction (cell reaction) will increase relatively in a short period of time. As a result, there is a problem of a significant reduction in the capacity of a redox battery.

In the vanadium active material solution in which the battery capacity is reduced, the compatibility of the produced suspensible active material (referred to as a dispersoid) with a liquid (dispersion medium) is not sufficient, and the crystal growth and/or aggregation of the dispersoid continues. In such a vanadium active material solution, the dispersoid in which crystal growth and/or aggregation continues will have a size where cell reaction with the active material on the surface of the electrode is actually impossible. The dispersoid having such a size greatly differs depending on the composition on the liquid side. When sulfuric acid is present at a sufficient concentration, the size of the dispersoid exceeds about 100 μm as a diameter. A solid (sludge-like) vanadium redox battery and the like have been proposed as a battery using an active material having a size exceeding 100 μm. However, as described above, the active material having such a particle size cannot provide sufficient electrode reaction, can produce only low input/output density, and cannot respond to fast charge and discharge and the like.

The present invention has been made in order to solve the above problems. An object of the present invention is to provide a vanadium active material solution in which the vanadium active material includes a dispersoid (suspensible material) and which has a vanadium active material concentration of 2.5 M or more in a sulfuric acid solution. Other objects of the present invention are to provide a vanadium active material solution which can stably maintain high energy density based on the concentration of the vanadium active material and can respond also to fast charge and discharge, and to provide a vanadium redox battery using the active material solution.

### Solution to Problem

(1) The vanadium active material solution according to the present invention for solving the above problems comprises a vanadium compound, which is an active material, as a solute and a dispersoid, wherein the total concentration of vanadium is 2.5 M or more. According to this invention, the concentration of the vanadium active material can be 2.5 M or more in a sulfuric acid solution including the dispersoid (suspensible material). Therefore, the vanadium active material solution according to the present invention can be used as an active material solution for redox batteries which can stably maintain high energy density and can respond also to fast charge and discharge.

In the vanadium active material solution according to the present invention, the average diameter of the dispersoid can be in the range of 1 nm or more and 100 μm or less. According to this invention, since the vanadium active material solution contains a fine (100 μm or less in diameter) dispersoid (suspensible material), the vanadium active material solution can be used to constitute a vanadium redox battery which is used stably repeating charge and discharge.

In the vanadium active material solution according to the present invention, the vanadium active material solution can be a negative electrolyte, wherein the vanadium compound comprises one or both of bivalent and trivalent vanadium.

In the vanadium active material solution according to the present invention, the vanadium active material solution can be a positive electrolyte, wherein the vanadium compound comprises one or both of quadrivalent and pentavalent vanadium.

In the vanadium active material solution according to the present invention, the vanadium active material solution can be an active material solution, wherein the vanadium compound comprises one or both of trivalent and quadrivalent vanadium.

(2) The vanadium redox battery according to the present invention for solving the above problems comprises at least a single cell structure in which a positive electrode, a positive electrolyte, a diaphragm, a negative electrolyte, and a negative electrode are arranged in this order. Further, the negative electrolyte and the positive electrolyte are vanadium active material solutions comprising a vanadium compound, which is an active material, as a solute and a dispersoid, and the total concentration of vanadium is 2.5 M or more.

In the vanadium redox battery according to the present invention, the average diameter of the dispersoid can be in the range of 1 nm or more and 100 μm or less.

In the vanadium redox battery according to the present invention, the vanadium compound constituting the negative electrolyte can comprise one or both of bivalent and trivalent vanadium. The vanadium compound constituting the positive electrolyte can comprise one or both of quadrivalent and pentavalent vanadium. However, in the case of an overdischarge state, in the case where the depth (state) of charge between positive and negative solutions is significantly unbalanced, in the case of a newly prepared active material solution, and the like, quadrivalent vanadium may be contained in the negative electrolyte, and trivalent vanadium may be contained in the positive electrolyte.

In the vanadium redox battery according to the present invention, the vanadium redox battery can comprise a conductive carbon fiber aggregate for circulating or injecting the vanadium active material solution.

In the vanadium redox battery according to the present invention, the conductive carbon fiber aggregate can comprise carbon fibers each having an average diameter in the range of 0.1 μm or more and 10 μm or less.

### Advantageous Effects of Invention

The present invention can provide a vanadium active material solution in which the vanadium active material includes a dispersoid (suspensible material) and which has a vanadium active material concentration of 2.5 M or more in a sulfuric acid solution. Further, the present invention can provide a vanadium active material solution which can stably maintain high capacity (Ah) and high energy density (Wh/L) based on the concentration of the vanadium active material and can respond also to fast charge and discharge, and can provide a vanadium redox battery using the active material solution.

Particularly, the vanadium active material solution according to the present invention contains a part of the vanadium active material as a dispersoid (suspensible material), and the total of the concentrations of all the vanadium active materials is 2.5 M or more. Therefore, the vanadium active material solution according to the present invention has an advantage of not being a conventional difficult means of producing a clear vanadium active material solution at a high concentration in which the precipitation of a fine solid is prevented and using the solution, while repeating charge and discharge, with maintaining the clear state. Further, the vanadium redox battery is a practical battery in terms of being capable of producing high input/output density compared with a vanadium redox battery constituted of an active material mainly comprising a solid (dispersoid) of a vanadium compound.

### BRIEF DESCRIPTION OF THE DRAWINGS

FIG. 1 is a schematic diagram showing an example of a single cell structure constituting a vanadium redox battery according to the present invention;

FIG. 2 is a schematic perspective view of the vanadium redox cell in which the single cell structures of FIG. 1 are connected in series;

FIG. 3 is a system block diagram of a vanadium redox battery;

FIG. 4 is a schematic diagram showing a method for producing an active material solution for a positive electrode and an active material solution for a negative electrode of a conventional type;

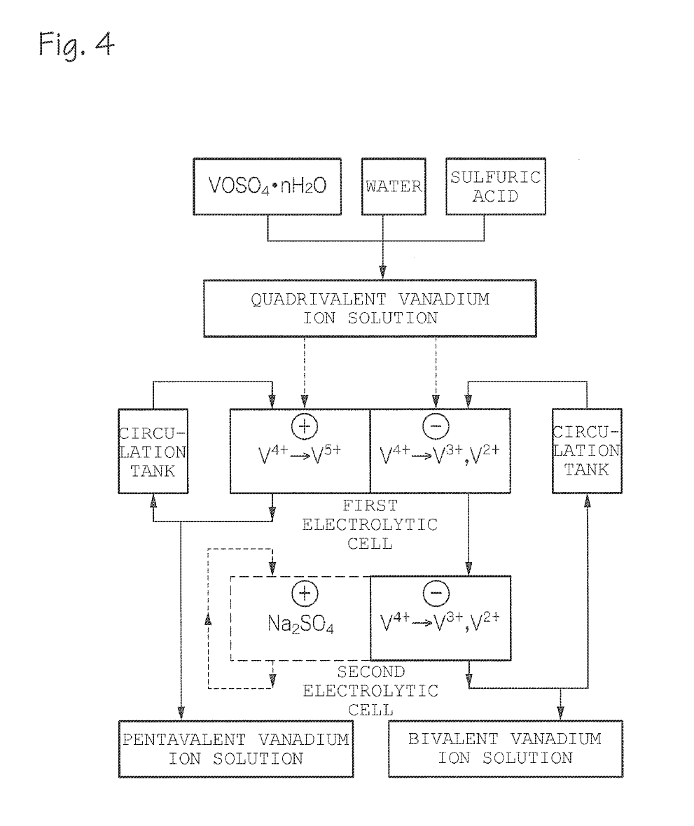

FIG. 5 is a schematic diagram illustrating the principle of a conventional common vanadium redox battery;

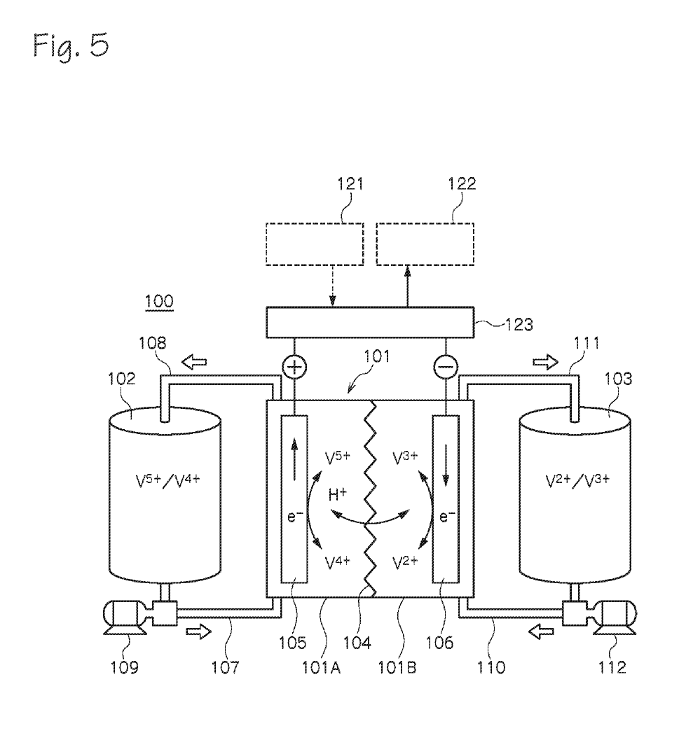

FIG. 6 shows the results of observation of a solid in a vanadium active material solution. FIG. 6 (A) shows a dispersoid floating in a prepared vanadium active material solution. FIG. 6 (B) shows a dispersoid adhering to the carbon felt of a negative electrolyte after the vanadium active material solution is electrolyzed. FIG. 6 (C) shows a dispersoid adhering to the carbon felt of a positive electrolyte after the vanadium active material solution is electrolyzed;

FIG. 7 shows an explanatory diagram (A) of a button type battery used for a charge test and a schematic diagram (B) of a charge and discharge test;

FIG. 8 is a current-potential curve in Experiment 2-1 measured for a suspensible active material solution (3 M active material/3 M H₂SO₄) reduced at 900 mA;

FIG. 9 is a current-potential curve in Experiment 2-2 measured for a suspensible active material solution (3 M active material/3 M H₂SO₄) to which 2 M (mol) of a microcrystalline active material is added;

FIG. 10 is a current-potential curve in Experiment 2-3 measured for a nonsuspensible active material solution (1.5 M active material/3 M H₂SO₄) which is diluted by a factor of two;

FIG. 11 is a current-potential curve in Experiment 2-4 measured for an active material solution in which 1 M HCl is added to the active material solution in Experiment 2-1 (3 M active material/3 M H₂SO₄);

FIG. 12 is a charge and discharge voltage curve of a button type battery using an ion exchange membrane (diaphragm) in which a solid active material is inserted, as a positive electrode and a negative electrode, respectively.

### DETAILED DESCRIPTION OF THE INVENTIONS

A vanadium active material solution and a vanadium redox battery according to the present invention will be described with reference to drawings. Note that the technical scope of the present invention is not limited to the following description of embodiments and drawings as long as it is the scope including the gist of the present invention.

### Vanadium Redox Battery

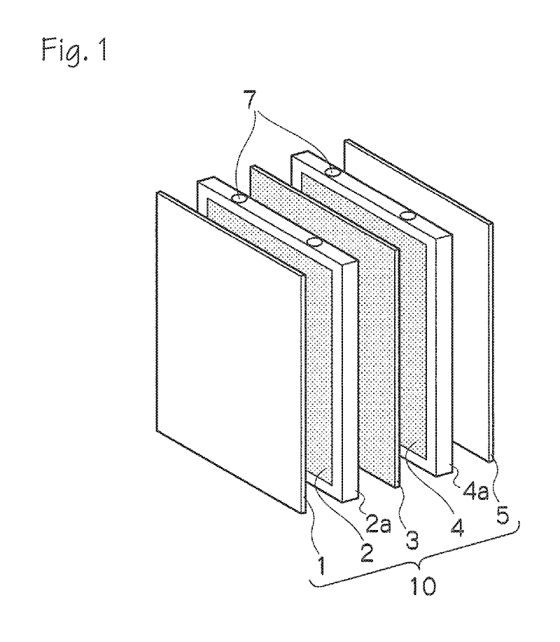

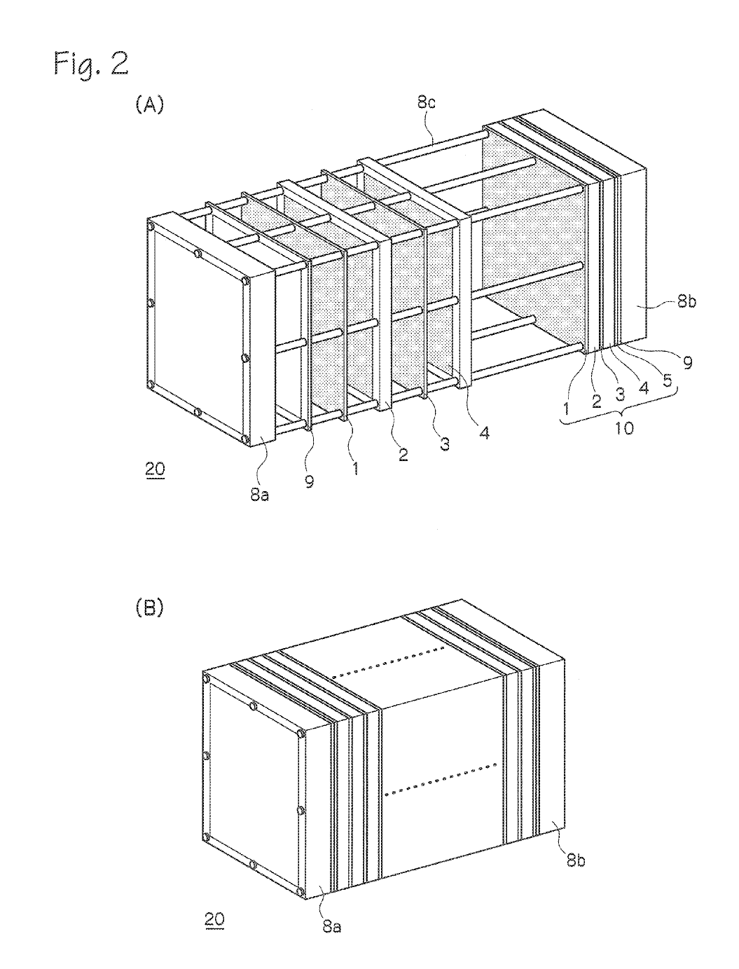

A vanadium redox battery 20 according to the present invention comprises at least a single cell (also referred to as a cell) structure 10 in which a positive electrode 1, a positive electrolyte 2, a diaphragm 3, a negative electrolyte 4, and a negative electrode 5 are arranged in this order, as illustrated in FIGS. 1 and 2. The vanadium redox battery 20 has a positive electrolyte 2 and a negative electrolyte 4. The positive electrolyte 2 and the negative electrolyte 4 are both a vanadium active material solution containing a vanadium compound as a dispersoid (including a suspensible material, hereinafter the same), wherein the total concentration of vanadium including the dispersoid is 2.5 M or more.

The vanadium compound constituting the negative electrolyte 4 comprises one or both of bivalent and trivalent vanadium. The vanadium compound constituting the positive electrolyte 2 comprises one or both of quadrivalent and pentavalent vanadium. Note that the “dispersoid” refers to a precipitate of a vanadium compound. The dispersoid is contained in both the positive electrolyte 2 and the negative electrolyte 4. The composition of a dispersoid may be the same as or different from the solution composition of the vanadium active material solutions 2 and 4 in which the dispersoid is suspended. However, the composition of a dispersoid is normally the same or almost the same as the composition of the vanadium active material solutions 2 and 4. Therefore, the composition of a dispersoid contained in the negative electrolyte 4 is the same or almost the same as the composition of the negative electrolyte 4. Further, the composition of a dispersoid contained in the positive electrolyte 2 is the same or almost the same as the composition of the positive electrolyte 2.

Such a vanadium redox battery 20 has high electricity storage capacity and high energy density and can provide a stable battery in which fast charge and discharge is possible. In particular, the positive electrolyte 2 and the negative electrolyte 4 which are vanadium active material solutions contain a vanadium compound as a dispersoid, and the total concentration of vanadium including the dispersoid is 2.5 M or more. As a result, this is not a conventional difficult means of producing a clear vanadium active material solution at a high concentration in which the precipitation of a fine dispersoid is prevented and using the solution, while repeating charge and discharge, with maintaining the clear state. Therefore, it has been able to constitute a vanadium active material solution with a simple means in both production and control and to constitute a vanadium redox battery.

Hereinafter, each component of the vanadium redox battery will be described.

### Vanadium Active Material Solution

The vanadium redox battery 20 comprises the positive electrolyte 2 and the negative electrolyte 4 which are vanadium active material solutions. Then, the vanadium redox battery 20 comprises, as a constituent unit, a single cell structure 10 in which the positive electrolyte 2 and the negative electrolyte 4 are arranged with the diaphragm 3 therebetween. Such vanadium active material solutions 2 and 4 (meaning the positive electrolyte 2 and the negative electrolyte 4, hereinafter the same) contain a vanadium compound as a dispersoid, and the total concentration of vanadium including the dispersoid is 2.5 M or more. When the vanadium active material solutions 2 and 4 contain high-concentration vanadium of 2.5 M or more, high electricity storage capacity and high energy density can be achieved.

The vanadium active material solutions 2 and 4 are aqueous electrolytic solutions (refer to active material solutions) containing at least soluble ions of a vanadium compound (solute), a dispersoid which are suspensible fine particles of a vanadium compound, sulfate ions (actually, mainly hydrogensulfate ions), and water. Therefore, the “vanadium concentration including a dispersoid” means the total of the vanadium concentration constituting a dispersoid of a vanadium compound suspended in an active material solution and vanadium concentration constituting a vanadium compound dissolved in an active material solution.

### Vanadium Compound Ions

The soluble ions of a vanadium compound (solute) are vanadium compound ions dissolved in the active material solution. Examples of the soluble ions include hydrated ions of bivalent to pentavalent vanadium, ions incorporating oxygen atoms such as VO²⁺ and VO₂⁺, or compound ions or the like in which hydrogensulfate ions are coordinated. When these soluble ions are charged in the positive electrolyte 2, these soluble ions will become one or both of quadrivalent and pentavalent vanadium compound ions. When these soluble ions are charged in the negative electrolyte 4, these soluble ions will become one or both of bivalent and trivalent vanadium compound ions. Further, during the discharge, one or both of trivalent and quadrivalent vanadium compound ions are produced.

### Vanadium Compound as Dispersoid

The vanadium compound as a dispersoid, which is present in the active material solution, refers to a material having cell reaction activity among an undissolved material of a vanadium compound which is a raw material and/or undissolved divalent to pentavalent vanadium compounds. Specific examples include oxides of vanadium, hydrogensulfates, and complex compounds thereof.

The dispersoid having cell reaction activity comprises fine particles having an average diameter in the range of 10⁻³ μm or more and 100 μm or less. The particles having such an average diameter show satisfactory cell reactivity on the electrode of carbon fiber. The average diameter is an average diameter which those skilled in the art normally understand. For example, in the case of a spherical shape or an approximately spherical shape, the average diameter is an average value of the diameter thereof. In the case of an odd shape other than the above, the average diameter is an average value when the average of the major axis and the minor axis is defined as the diameter.

### Vanadium Concentration

The vanadium concentration is the total of the vanadium concentration of vanadium compound ions dissolved in the active material solution and the vanadium concentration of a dispersoid which is an undissolved vanadium compound. In the present invention, the total vanadium concentration is 2.5 M or more, and when these compounds (the dissolved vanadium compound ions and the undissolved vanadium compound) satisfactorily perform a cell reaction, a battery having high energy density can be constituted. Although the upper limit of the vanadium concentration is not limited, it is difficult to exceed 5 M in terms of specific volume. Since the vanadium active material solution having a vanadium concentration in this range contains vanadium effective in a high-concentration cell reaction, it has high electricity storage capacity and high energy density. Further, the present invention is not inferior in fast charge and discharge compared with a battery in which all vanadium compounds are dissolved.

Note that, if the vanadium concentration is less than 2.5 M, the battery cannot be said to have sufficiently high electricity storage capacity, and cannot be said to have sufficiently high energy density. Thus, it may not be able to be said that the battery sufficiently has responded to the requirement of a high-performance electrolytic solution for a redox battery. Note that, the above upper limit is a realistic numerical value that can be obtained by dissolution. However, the upper limit is not necessarily limited to this value, but may be higher than the value.

In Examples to be described below, experiments have been performed at a maximum vanadium concentration of 4.9 M, but a practically particularly preferred vanadium concentration is in the range of 2.5 M or more and 5 M or less. A vanadium active material solution having a vanadium concentration in this range is easily produced and can supply a sufficient amount of an active material to an electrode. Therefore, the vanadium active material solution can be preferably used as an active material solution for a circulating flow battery having high energy density or as an active material solution for a battery which is intermittently flown or stopped. Note that the vanadium concentration can be determined from the results obtained by an electrochemical analysis method as well as fluorescent X-ray analysis, ion chromatography, ICP mass analysis, atomic absorption spectrophotometry, and the like.

### Sulfuric Acid

When the active material solution is prepared from vanadyl sulfate, sulfuric acid is excessively added in the range of 1 M to 5 M in terms of the concentration of a sulfate group relative to the concentration of vanadium. This not only improves the electrode reactivity but also increases the stability of the positive electrode active material solution since large crystal grains are hardly produced on the side of the positive electrode active material solution.

### Water

Pure water, distilled water, ion-exchanged water, and the like are preferably used as water.

### Additive

The vanadium active material solution may contain an additive in order to improve stability and reduce viscosity. For example, a suitable amount of hydrochloric acid, phosphoric acid, or the like may be added as an additive. Hydrochloric acid has the effect of improving stability and reducing viscosity particularly on the side of the positive electrolyte, and the improvement is observed when about 1 M of hydrochloric acid is added, depending on the vanadium concentration. Phosphoric acid improves the stability on the side of the negative electrolyte.

The vanadium active material solution may contain conductive powder in order to improve electrical conductivity. Various materials can be used as conductive powder as long as it is acid-resistant electrically conductive powder. Specific examples of preferred conductive powder include carbon materials, such as graphite and graphene. With respect to the size of the conductive powder, the conductive powder may be sieved, for example, through a sieve of 400 meshes or more, or the conductive powder may have an average particle size, for example, in the range of about 300 μm to 700 μm. Thus, the size of the conductive powder can be arbitrarily selected for use.

### Preparation of Dispersoid in Vanadium Active Material Solution

For preparing a high concentration active material solution in the present invention, sulfuric acid is added, for example, to about 3.5 M vanadyl sulfate aqueous solution to perform electrolytic reduction and the like to convert about 1.75 M of vanadyl sulfate to a trivalent vanadium compound. This converts the active material solution to a solution of vanadium having an average redox state of 3.5 valent vanadium, and when charge is started from here in the case of a secondary battery, the 3.5 valent vanadium will be converted to pentavalent vanadium, which is in a charged state, through quadrivalent vanadium on the side of the positive electrolyte. On the other hand, on the side of the negative electrolyte, the 3.5 valent vanadium will be converted to bivalent vanadium, which is in a charged state, through trivalent vanadium. In the case of discharge, the valence conversely changes, and in a fully discharged state, vanadium is converted to quadrivalent vanadium in the positive electrolyte and trivalent vanadium in the negative electrolyte.

In this method for preparing an active material solution, the 3.5 M vanadyl sulfate aqueous solution is obtained in the state where it is completely dissolved. The completely dissolved state can be verified by the fact that an aqueous solution put in an absorbance cell having a short (for example, 1 mm) optical path length transmits light without scattering. When a proper amount of sulfuric acid is added to the solution to reduce it (electrolytic reduction and the like), scattered light can be measured from the light irradiated into the absorbance cell, which shows the occurrence of suspension in the solution. This suspension occurs when crystalline active material fine particles serve as a dispersoid, and it is important to prevent excessive crystal growth by performing timely stirring and the like. In this method for preparing an active material solution, a high concentration active material solution can be preferably prepared not only from a solution in which the 3.5 M vanadyl sulfate is completely dissolved but also from a 5 M vanadyl sulfate suspension (slurry) in a suspended state by performing electrolytic reduction.

On the other hand, even if the temperature of the active material solution is increased by adding sulfuric acid, a suspensible active material solution containing a fine particle dispersoid is formed by adding sulfuric acid in a short time or by performing rapid electrolytic reduction at high current density (for example, apparent current density per electrode surface being 0.5 to 1.0 A/cm²). When the diameter of the suspensible fine vanadium compound is approximately nanometer level to 100-μm level (about 1 nm to 100 μm), the suspensible fine vanadium compound will be strongly influenced by the affinity with a sulfuric acid aqueous solution to prevent the production of a precipitate by aggregation and/or crystal growth. Further, the suspensible fine vanadium compound has the reactivity as an active material because of the fine particle diameter thereof. When the suspension containing the fine vanadium compound is subjected to visible absorption spectrum measurement, the position of the absorption of the vanadium compound or ions will be shifted to the long wavelength side by the increase in sulfuric acid concentration or halide ion concentration. This shift suggests that the suspensible fine vanadium compound is more stable in a solvent or a dispersion medium. Therefore, the temperature increase by the sulfuric acid addition and the magnitude of electrolytic current density will not be a big problem in the preparation of an active material solution.

In the active material solution prepared by such a method, the dispersoid will have a diameter of from nanometer to submicron. Then, the occurrence of aggregation and/or crystal growth of the dispersoid produced in the active material solution is suppressed by allowing the active material solution to flow at a proper interval (for example, about once a day). As a result, the active material solution can be used for a stable battery.

Even if the vanadium active material solution obtained by the preparation of the active material solution as described above has a high concentration of about 2.5 M to 5 M, the active material solution utilization rate (the proportion of the active material participating in charge and discharge) when the active material solution is used in a secondary battery can be, for example, about 80% (the depth of charge being about 90%, and the depth of discharge being about 90%). Further, the vanadium active material solution can maintain high charge and discharge efficiency (high potential efficiency in which internal resistance is suppressed small, and high coulombic efficiency in which side reaction is suppressed) over a long period of time.

### Electrolytic Treatment

An active material solution precursor having a vanadium concentration of 2.5 M to 5 M in the form of a solution or a suspension is subjected to electrolytic treatment. With respect to reduction treatment, the average redox state is adjusted to 3.5 valence by the electrolytic reduction in which oxygen evolution reaction or the like occurs at the counter electrode. Note that the average redox state can be easily verified by potentiometry, voltammetry, coulometry, absorptiometry, and the like.

### Vanadium Active Material Solution Containing Dispersoid

The action and effect of the vanadium active material solution according to the present invention containing a dispersoid will be described below. As usual, in the vanadium active material solution having a high vanadium concentration, the positive electrolyte is normally in the state where vanadium oxide (V₂O₅) is easily precipitated if the sulfuric acid concentration is not sufficiently high in terms of equilibrium theory. In this case, in the positive electrolyte, the sulfuric acid concentration can be further increased to increase solubility to prevent easy precipitation of vanadium oxide. On the other hand, on the side of the negative electrode, there has been a disadvantage that when the sulfuric acid concentration is increased, the solubility of divalent vanadium ions will be reduced.

As a method of suppressing the precipitation of vanadium oxide, it has also been studied that the solubility of vanadium oxide is improved by adding chloride ions. However, if the nucleus of vanadium oxide is produced in the active material solution, the nucleus will undergo crystal growth to form a precipitate. As a result, there has been a disadvantage that many precipitates are produced in the active material solution. Although the addition of phosphoric acid is also studied as a preventive measure of precipitation in the negative electrolyte, there is a disadvantage that phosphoric acid may serve as a precipitant in the positive electrolyte.

When the aqueous solution of vanadyl sulfate which is present as quadrivalent vanadium ions is subjected to electrolytic reduction by adding sulfuric acid when required, the valence will change (quadrivalent→trivalent, divalent). However, depending on the speed of change of the valence, the change of composition to a stable complex in each valence may not follow the speed. Therefore, when a solution in which the change of composition to a stable complex does not follow the speed is allowed to stand still, a precipitate may be produced from a composition in which ligand substitution reaction to a stable complex has been completed. Even in such a solution, the present invention will achieve high energy density by maintaining a precipitate as fine particles having cell reaction activity.

Generally, in a negative electrolyte, since the solubility of divalent vanadium ions is reduced particularly by increasing sulfuric acid concentration, it is believed that a divalent vanadium compound is precipitated if the depth of charge is increased. Therefore, a vanadium active material solution having a vanadium concentration of 2 M or less has been used in consideration of the solubility of a vanadium compound. On the other hand, in a positive electrolyte, it has been believed that a precipitate of an oxide such as V₂O₅ is easily generated unless sulfuric acid concentration is sufficiently excessive.

When an electrolytic solution in which 2 M to 3 M sulfuric acid is added to a 3 M vanadyl sulfate solution or suspension is subjected to electrolytic reduction, a negative electrolyte can be prepared without producing a precipitate. The reason is probably because vanadyl ions form a vanadium active material solution containing divalent or trivalent vanadium ions while maintaining the coordination effect of HSO₄⁻ ions. However, when such a vanadium active material solution is allowed to stand for a long time, a polynuclear complex having aquo ions will probably be produced to reduce solubility to produce a precipitate.

By the occurrence of ligand exchange as described above, a precipitate is probably produced from a vanadium active material solution having a concentration exceeding solubility, even if there is a time difference. At this time, if a fine precipitate can be maintained as it is by preventing crystal growth, the fluidity of an electrolytic solution can be maintained. Further, if the fine precipitate can be precipitated in a felt made of carbon fiber, the precipitate can be effectively utilized as an active material. This can result in a function as a battery having a high concentration electrolytic solution. The present invention provides the action and effect obtained by such a mechanism.

### Vanadium Redox Battery

A vanadium redox battery can be made into various forms. A vanadium redox battery 10 shown in FIG. 1 shows a single cell structure. In the vanadium redox battery 10, a positive electrode 1, a positive electrolyte 2, a diaphragm 3, a negative electrolyte 4, and a negative electrode 5 are arranged in this order. Note that the positive electrolyte 2 and the negative electrolyte 4 are injected inside cell frames 2a and 4a, respectively, as shown in FIG. 1. Inlets 7 for injecting the electrolytic solutions are provided in these cell frames 2a and 4a. These inlets 7 are optionally used as circulation ports of the electrolytic solutions. Note that the material, size, thickness, and the like of the cell frames 2a and 4a are not particularly limited as long as the cell frames are made of a material, size, and the like that can be used with no problem.

A vanadium redox battery 20 shown in FIG. 2 is a battery prepared by series-connecting a plurality of single cell structures 10 shown in FIG. 1. Such series connection can increase voltage. Note that reference numerals 8a and 8b denote end plates provided on both ends. Reference numeral 8c denotes a clamping jig for clamping the end plates 8a and 8b. However, such a jig is an example for series-connecting the single cell structures, and is not limited to the shown form. Further, reference numeral 9 denotes a current collector provided on both ends of the single cell structures 10.

The vanadium redox battery can be made into various forms in addition to the form shown in FIGS. 1 and 2. For example, the vanadium redox battery may have a single cell structure (not shown) in which a positive electrode 1 with a pasty positive electrolyte 2 coated thereon and a negative electrode 5 with a negative electrolyte 4 coated thereon are bonded together with a diaphragm 3 therebetween. Then, a battery pack may be prepared by laminating a plurality of the single cell structures. Further, a form like a dry cell may be obtained by forming the single cell structure into a long band and winding the band on a core (for example, carbon rod).

### Positive Electrolyte, Negative Electrolyte

Since the positive electrolyte 2 and the negative electrolyte 4 have been already described in the description column of the vanadium active material solution, the description will be omitted here. Note that the positive electrolyte 2 and the negative electrolyte 4 may be a liquid having good fluidity or may be a paste having poor fluidity as long as they are electrolytic solutions containing a dispersoid of a vanadium compound. When the vanadium active material solution is a liquid, it can be filled inside the cell frames 2a and 4a shown in FIG. 1. When the vanadium active material solution is a paste, the positive electrolyte 2 and the negative electrolyte 4 can be coated on the positive electrode 1 and the negative electrode 5, respectively.

### Conductive Carbon Fiber Aggregate

The positive electrolyte 2 and the negative electrolyte 4 may be arranged with the diaphragm 3 therebetween in the state where each conductive carbon fiber aggregate is soaked with each of the electrode solutions. The conductive carbon fiber aggregate includes various commercially available aggregates. Examples thereof include conductive carbon fiber aggregates made of pitch-based carbon fiber and those made of PAN (Polyacrylonitrile)-based carbon fiber. The shape, size, and the like of the conductive carbon fiber aggregate can be made the same as the above cell frames 2a and 4a filled with the electrolytic solutions.

Since the conductive carbon fiber aggregate is an aggregate of fibers, the vanadium active material solution can be circulated through the pores between fibers. As a result, the conductive carbon fiber aggregate is used by circulating or intermittently circulating or stopping the vanadium active material solution. Further, even in the case of stopping the vanadium active material solution, the conductive carbon fiber aggregate can be preferably used because the fluidity of the active material solution and ions therein is not inhibited.

Since the conductive carbon fiber aggregate is an aggregate of fibers, a dispersoid of a vanadium compound can be supported therein. The conductive carbon fiber aggregate can uniformly support a fine dispersoid all over the aggregate. The advantage of uniformly supporting a fine dispersoid resides in that the dispersoid of a vanadium compound acting as an active material can charge and discharge at a uniform current density over the whole electrode surface of a battery without the variation of concentration distribution. Such uniformity will be naturally equalized, if it is a liquid. However, in the case of a dispersoid, it is preferably supported particularly when it is a dispersoid that may settle in the active material solution even if it has a particle size within the scope of the present invention.

The fibers constituting the conductive carbon fiber aggregate may be conductive carbon fibers having an average diameter within the following range. For example, the fibers constituting the conductive carbon fiber aggregate may be carbon fibers prepared by advancing firing to reduce the diameter or may be fibers coated with a conductive material such as carbon. When the conductive carbon fiber aggregate is constituted of carbon fibers, the average diameter of the carbon fibers is in the range of 10⁻³ μm or more and 10 μm or less, preferably in the range of 0.1 μm to 5 μm. When the aggregate is constituted of carbon fibers having such an average diameter, there will be an advantage of improving the material mobility of the cell active material that arrives at the surface of carbon fibers. The average diameter of carbon fibers is preferably in the range of 10⁻³ μm or more and 5 μm or less in terms of sufficiently improving material mobility.

### Diaphragm

A diaphragm 3 is provided between a positive electrolyte 2 and a negative electrolyte 4. The diaphragm 3 is an ion exchange membrane having certain oxidation durability. Examples of the diaphragm include a membrane of Nafion 117 or Nafion 115 ((R), E.I. du Pont de Nemours and Company), a polyolefin-based membrane, and a polystyrene-based membrane. The ion species which permeate through the ion exchange membrane are mainly protons (hydrate). However, since protons easily permeate also through an anion exchange membrane, a diaphragm having sufficient ion exchange capacity may be preferably used.

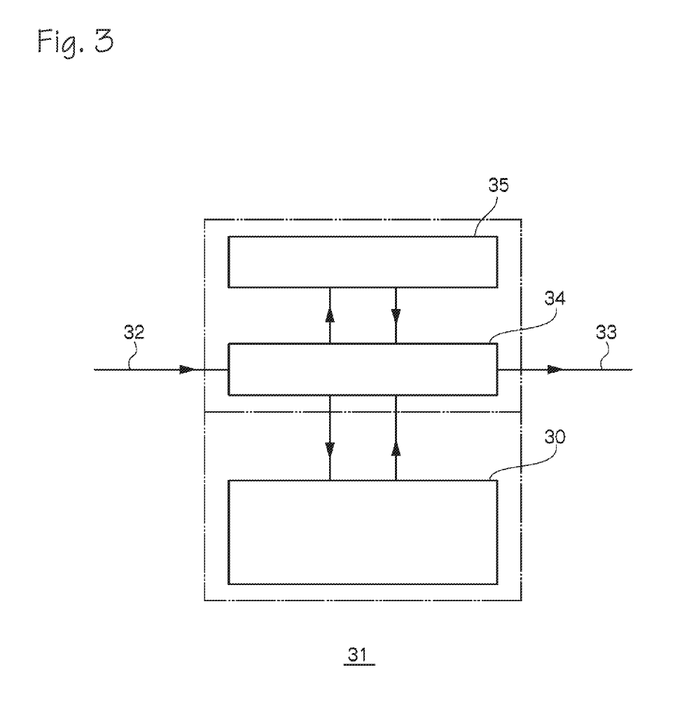

In the case of a laminated (cell-stacked) battery, the positive electrode 1 and the negative electrode 5 are separated by a bipolar plate. The bipolar plate can be applied in the case of a vanadium redox battery 20 in which single cell structures are laminated so that they are connected in series. In the bipolar plate, the positive electrode 1 and the negative electrode 5 described above are not separately provided, but one surface of the bipolar plate acts as a positive electrode, and the other surface thereof acts as a negative electrode. Note that FIG. 3 is a block diagram of a system 31 of a vanadium redox battery. Reference numeral 30 denotes a vanadium redox battery. Reference numeral 31 denotes the system thereof. Reference numeral 32 denotes a charging power source. Reference numeral 33 denotes a load power source. Reference numeral 34 denotes an alternating current/direct current converter. Reference numeral 35 denotes a system controller.

### EXAMPLES

Hereinafter, the present invention will be more specifically described with reference to experimental examples. However, the present invention is not limited to the following examples.

### Experiment 1

First, vanadyl sulfate (IV) hydrate having a purity of 99.5% or more was weighed so that the vanadium concentration may finally be 3 M. Further, sulfuric acid was weighed so that the concentration as a sulfate group may finally be 6 M. The weighed vanadyl sulfate (IV) hydrate and sulfuric acid were mixed with water. Then, they were dissolved as much as possible. Then, a vanadium active material solution was prepared by injecting nitrogen gas into the mixture and deaerating it by bubbling nitrogen gas in a tank. Note that the actual sulfuric acid (added sulfuric acid) excluding the sulfate ions (3 M) constituting a vanadium compound is 3 M. The vanadium active material solution was electrolyzed and used as a positive electrolyte and a negative electrolyte. These solutions were chargeable and dischargeable at a discharge capacity of about 90% of the theoretical value determined from vanadium concentration.

### Results of Observation of Solid in Vanadium Active Material Solution

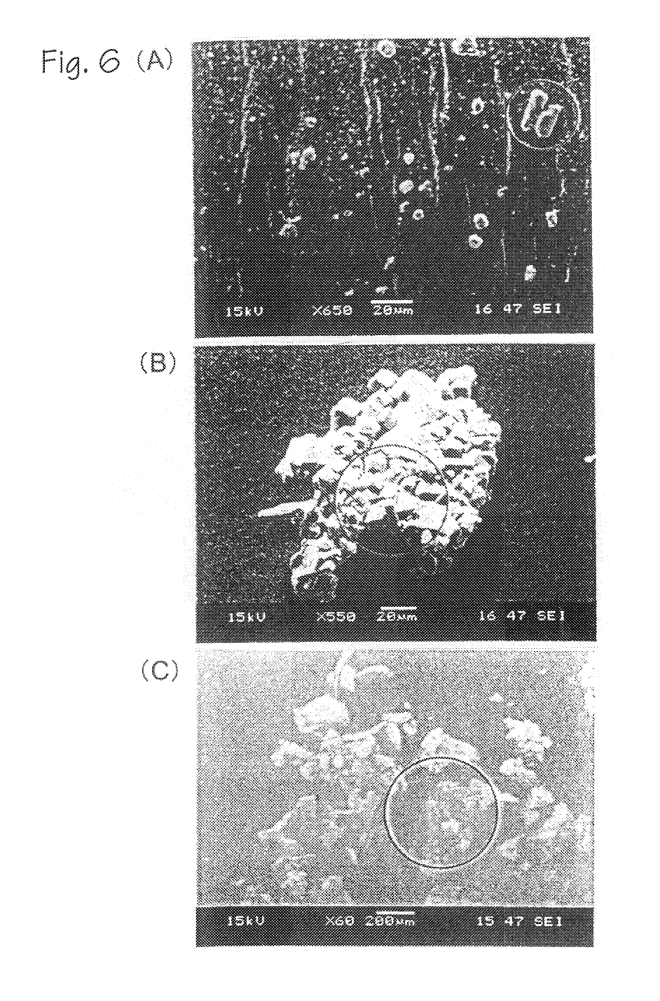

(1) A part of the prepared vanadium active material solution was filtered through a 0.2-μm filter to collect a dispersoid floating in the vanadium active material solution with the 0.20-μm filter. Although the amount of the collected dispersoid was small, the dispersoid was present. Further, the outline of the composition of the collected dispersoid was measured by energy dispersive X-ray spectroscopy. The collected dispersoid had an average particle size of about 8 μm from the observation by an electron microscope photograph. The ratio of the number of elements of V (vanadium):S (sulfur) was about 1:1 from the results of SEM-EDX measurement of the dispersoid. A compound having a ratio of the number of elements of V:S of 1:1 is VOSO₄, and it was assumed that this particle was a vanadyl sulfate crystal. Note that the electron microscope photograph is shown in FIG. 6 (A).

(2) Next, a vanadium active material solution which is not filtered was electrolyzed in an electrolytic cell in which carbon fiber was used as a working pole and oxygen evolution reaction occurs at a counter electrode (apparent current density per unit area of diaphragm: 900 mA/cm²). Then, charge and discharge were performed in a single-cell redox battery.

In order to take a dispersoid contained in a positive electrolyte 2 and a negative electrolyte 4 which were subjected to a charge and discharge test, cell frames 2a and 4a were removed, and a dispersoid adhering to carbon felt was collected. Further, the components of the dispersoid adhering to the carbon felt of the negative electrolyte 4 were analyzed. The dispersoid was an aggregate of angular particles having an average particle size calculated from the electron microscope photograph of about 5 to 10 μm. Further, from the results of SEM-EDX observation of the dispersoid, this dispersoid was also assumed to be, for example, reprecipitated VOSO₄ because the dispersoid had a ratio of the number of elements of V (vanadium):S (sulfur) of about 1:1 and was made of crystalline fine particles. Note that the electron microscope photograph of the dispersoid adhering to the carbon felt of the negative electrolyte 4 is shown in FIG. 6 (B).

The components of the dispersoid adhering to the carbon felt of the positive electrolyte 2 were analyzed. The dispersoid was an aggregate of columnar particles having an average particle size calculated from the electron microscope photograph of about 100 μm (major axis size). Further, as a result of measurement of the dispersoid by SEM-EDX, this dispersoid was assumed to be basic sulfate of vanadium (quadrivalent or pentavalent) because the dispersoid had a ratio of V (vanadium):S (sulfur) of about 2:1 and a particle form of columnar crystals. Note that the electron microscope photograph of the dispersoid adhering to the carbon felt of the positive electrolyte 2 is shown in FIG. 6 (C).

### Experiment 2

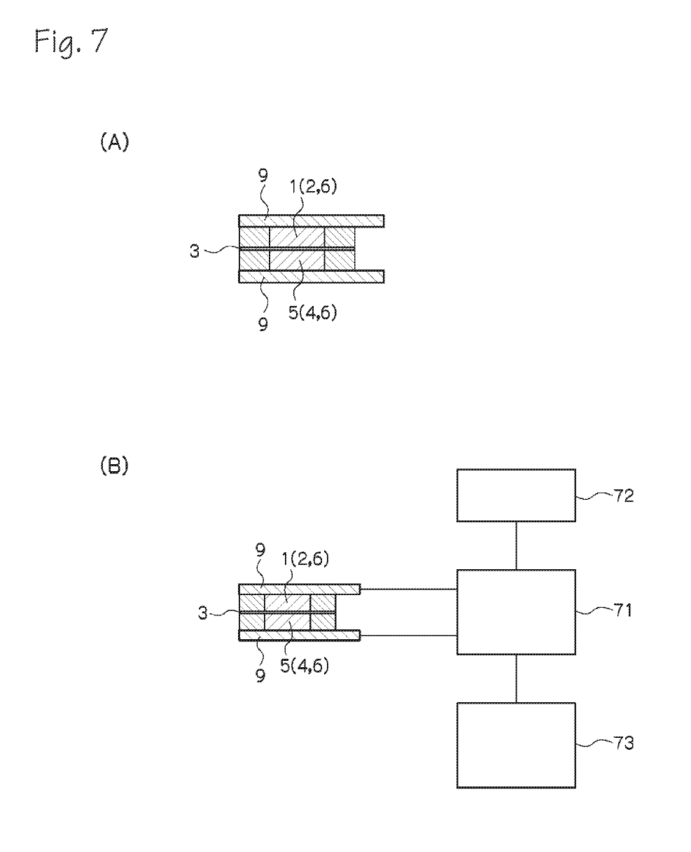

A charge and discharge test was performed. As shown in FIG. 7 (A), the battery used for the test was a button type battery (1 cm both in vertical and horizontal directions) in which a conductive carbon fiber aggregate electrode was soaked with an active material solution, and the battery was evaluated by a voltage sweep method (measurement of charge and discharge current). The button type battery had a thickness of 0.1 mm, a length of 1 cm, and a width of 1 cm, and had a structure in which two conductive carbon fiber aggregate sheets each having a thickness of 0.3 mm were piled and soaked with an active material solution. Further, the charge and discharge test was performed using a commercially available potentiostat testing machine, as shown in FIG. 7 (B). The measurement was performed at a sweep rate of applied voltage of 500 s/V⁻¹ and a solution temperature of 25° C., under a constant current condition. Note that in FIG. 7 (B), reference numeral 71 denotes a charging and discharging power source. Reference numeral 72 denotes a voltage sweep device. Reference numeral 73 denotes an XY recorder.

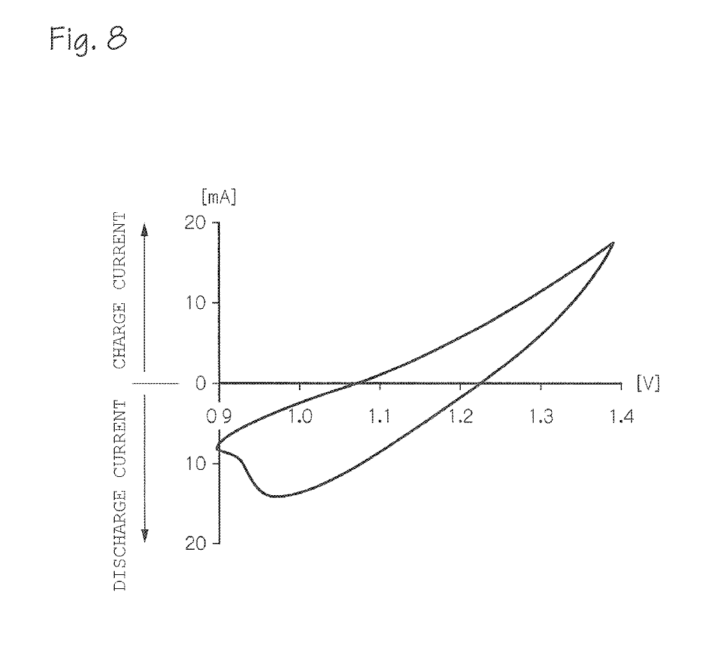

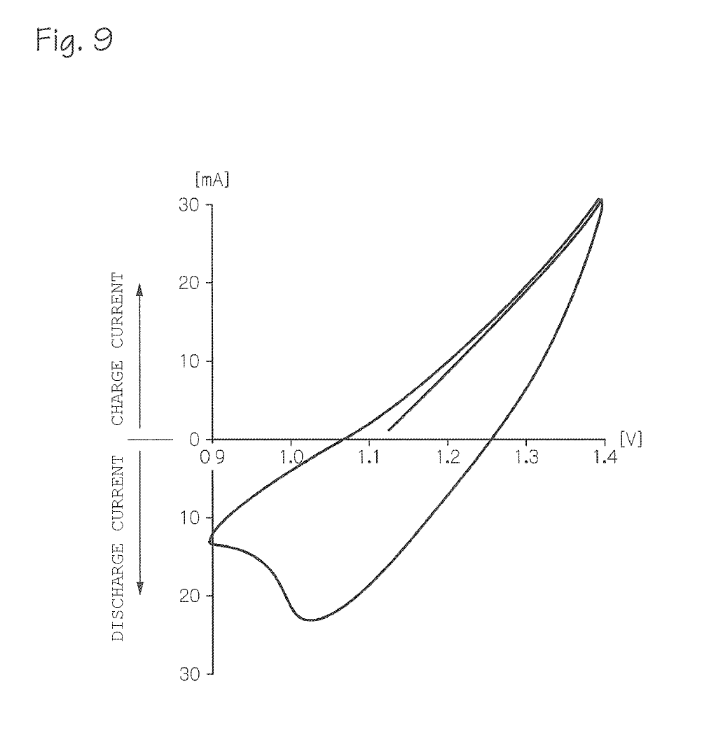

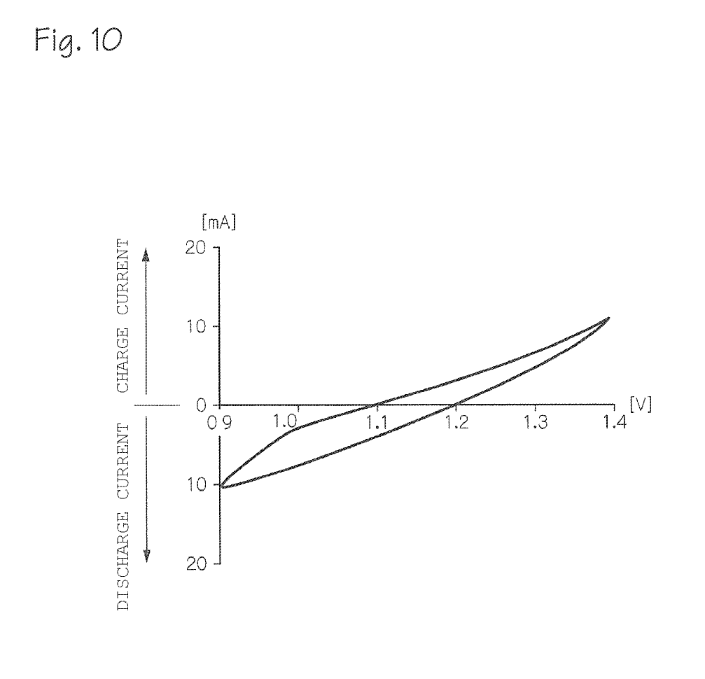

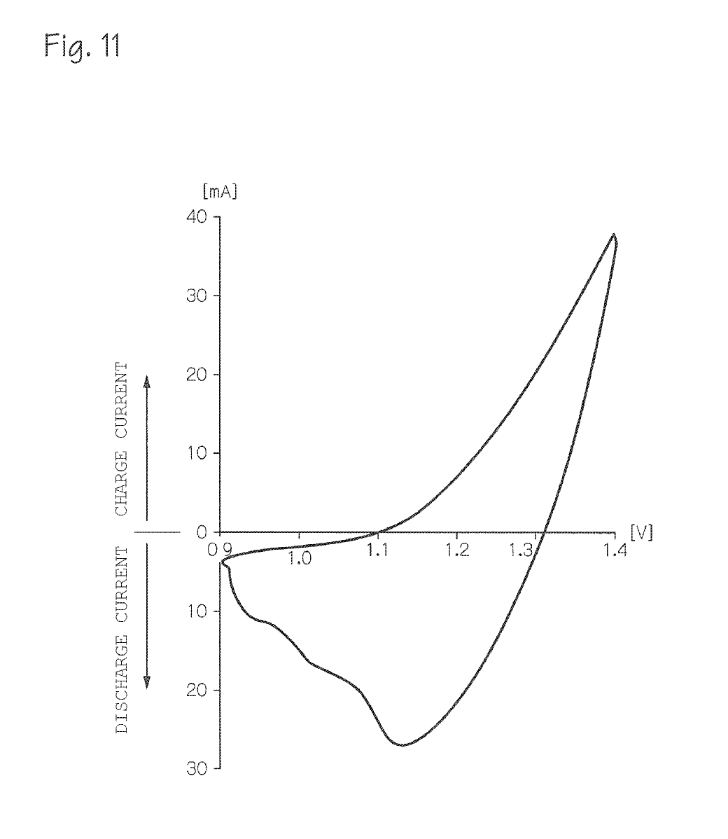

The current-potential curve shown in FIG. 8 is the results of measuring a suspensible active material solution (3 M active material/3 M H₂SO₄) reduced at 900 mA (Experiment 2-1). The current-potential curve shown in FIG. 9 is the results of measuring a suspensible active material solution (3 M active material/3 M H₂SO₄) to which 2 M (mol) of a microcrystalline active material was added (Experiment 2-2). The current-potential curve shown in FIG. 10 is the comparative experiment results of measuring a nonsuspensible active material solution (1.5 M active material/3 M H₂SO₄) which was diluted by a factor of two (Experiment 2-3). The current-potential curve shown in FIG. 11 is the results of measuring an active material solution in which 1 M HCl was added to the active material solution in Experiment 2-1 (3 M active material/3 M H₂SO₄) (Experiment 2-4). The evaluation results are shown in Table 1.

TABLE 1

| | | | Experiment | |
|---|---|---|---|---|
| Evaluation | Experiment | Experiment | 2-3 | Experiment |
| items | 2-1 | 2-2 | (comparison) | 2-4 |
| Discharge | 1.73 | 3.08 | 1.15 | 3.11 |
| capacity (coul.) | | | | |
| Coulombic | 85 | 97 | 83 | 99 |
| efficiency (%) | | | | |
| Maximum | 15 | 24 | 9 | 31 |
| output (mW) | | | | |

The results in Table 1 showed that the suspensible active material solutions in Experiments 2-1, 2-2 and 2-4 had high discharge capacity, coulombic efficiency, and maximum output (current×voltage: mW). Particularly, the suspensible active material solution to which 2 M (mol) of a microcrystalline active material was added (Experiment 2-2) and the active material solution to which 1 M HCl was added (Experiment 2-4) showed more excellent properties.

### Experiment 3

The negative electrolyte of sulfuric acid 3 M vanadium used in Experiment 2-1 was filtered through filter paper having a pore size of 0.47 μm, and the filtration residue on the filter paper was taken. Further, the positive electrolyte of sulfuric acid 2.5 M vanadium (the depth of charge being about 80%) was also subjected to filtration treatment similarly, and the filtration residue was taken. These filtration residues were mixed with the negative electrolyte and the positive electrolyte before filtration, respectively, and the resulting negative electrolyte and positive electrolyte were contained in a conductive carbon fiber aggregate to produce a negative electrode and a positive electrode, respectively, which were used for the trial production of a battery. This button type battery, which has the same constitution as that in FIG. 7 (A), is a stationary active material solution-type battery having an apparent electrode area of 1 cm² using a cation exchange membrane as a diaphragm. Specifically, it is a battery in which five conductive carbon fiber aggregate sheets were laminated; a PSS (polystyrene sulfonate)-based diaphragm was used; the electrode area was set to 1 cm²; the electrode chamber volume (about ⅓ being filled with an electrode) was set to 1 cm²×0.3 cm; and the assumed void was set to 0.2 mL.

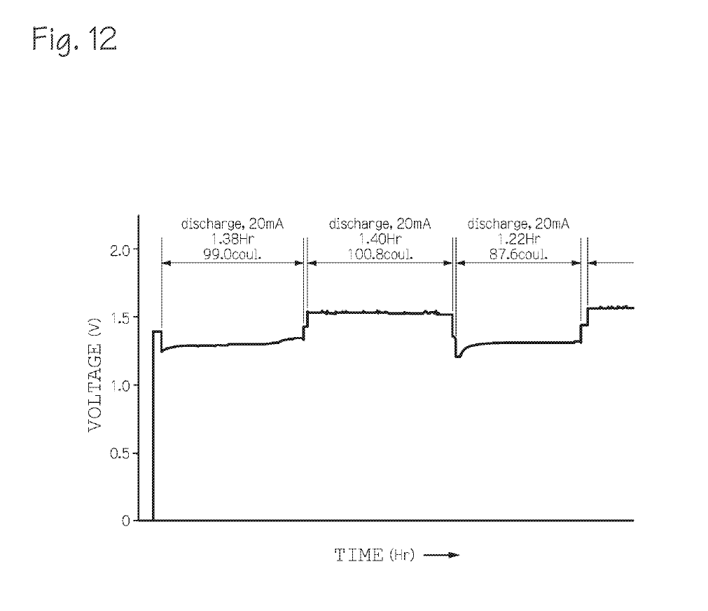

FIG. 12 is a charge and discharge voltage curve of a button type battery using an ion exchange membrane (diaphragm) in which a solid active material is inserted, as a positive electrode and a negative electrode, respectively. The measurement was performed with 20-mA constant current charge and discharge. The results are as shown in FIG. 12, in which the total charge quantity of electricity was 309.0; the total discharge quantity of electricity was 285.0; and ηcoul. (charge and discharge coulombic efficiency) was 92.2%. Note that the calculative active material concentration determined from discharge capacity was 4.9 M, and it was verified that a dispersoid effectively acted as an active material.

From the above results, it was possible to prepare a stable electrolytic solution that has high electricity storage capacity and high energy density and allows high-speed charge when the total concentration of vanadium in a vanadium active material solution including a dispersoid was set to 2.5 M or more (was 4.9 M in the experimental example), and further higher output voltage was able to be obtained.

### REFERENCE SIGNS LIST

1 Positive electrode
2 Positive electrolyte
2a Cell frame
3 Diaphragm
4 Negative electrolyte
4a Cell frame
5 Negative electrode
6 Conductive carbon fiber aggregate
7 Circulation port or inlet
8a, 8b End plate
8c Clamping jig
9 Current collector
10 Vanadium redox battery (single cell structure)
20 Vanadium redox battery
30 Vanadium redox battery
31 System of vanadium redox battery
32 Charging power source
33 Load power source
34 Alternating current/direct current converter
35 System controller
71 Charging and discharging power source
72 Voltage sweep device
73 XY recorder
100 Redox flow battery
101 Electrolytic cell
101A Positive electrode chamber
101B Negative electrode chamber
102 Positive-electrode electrolytic solution tank
103 Negative-electrode electrolytic solution tank
104 Diaphragm
105 Positive electrode
106 Negative electrode
107,108 Piping
109,112 Pump
110,111 Piping
121 Alternating current power source
122 Load power source
123 Alternating current/direct current converter

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. A vanadium active material solution comprising a vanadium compound, which is an active material, as a solute and a dispersoid, wherein a total concentration of vanadium is 2.5 M or more.

2. The vanadium active material solution according to claim 1, wherein an average diameter of the dispersoid is in the range of 1 nm or more and 100 μm or less.

3. The vanadium active material solution according to claim 1 wherein the vanadium active material solution is a negative electrolyte, wherein the vanadium compound comprises one or both of bivalent and trivalent vanadium.

4. The vanadium active material solution according to claim 1 wherein the vanadium active material solution is a positive electrolyte, wherein the vanadium compound comprises one or both of quadrivalent and pentavalent vanadium.

5. The vanadium active material solution according to claim 1 wherein the vanadium active material solution is an active material solution, wherein the vanadium compound comprises one or both of trivalent and quadrivalent vanadium.

6. A vanadium redox battery, comprising: at least a single cell structure in which a positive electrode, a positive electrolyte, a diaphragm, a negative electrolyte, and a negative electrode are arranged in this order, wherein the negative electrolyte and the positive electrolyte are vanadium active material solutions comprising a vanadium compound, which is an active material, as a solute and a dispersoid, and a total concentration of vanadium is 2.5 M or more.

7. The vanadium redox battery according to claim 6, wherein an average diameter of the dispersoid is in the range of 1 nm or more and 100 μm or less.

8. The vanadium redox battery according to claim 6 wherein the vanadium compound constituting the negative electrolyte comprises one or both of bivalent and trivalent vanadium, and the vanadium compound constituting the positive electrolyte comprises one or both of quadrivalent and pentavalent vanadium.

9. The vanadium redox battery according to any one of claim 6 comprising a conductive carbon fiber aggregate for circulating or injecting the vanadium active material solution.

10. The vanadium redox battery according to claim 9, wherein the conductive carbon fiber aggregate comprises carbon fibers each having an average diameter in the range of 0.1 μm or more and 10 μm or less.
